(19) United States
(12) Patent Application Publication
(10) Pub. No.: US 2022/0173395 A1
(43) Pub. Date: Jun. 2, 2022

(54) LITHIUM ION SECONDARY BATTERY

(71) Applicant: Prime Planet Energy & Solutions, Inc., Tokyo (JP)

(72) Inventor: Kento HOSOE, Miyoshi-shi (JP)

(21) Appl. No.: 17/536,120

(22) Filed: Nov. 29, 2021

(30) Foreign Application Priority Data
Dec. 1, 2020 (JP) 2020-199330

(51) Int. Cl. H01M 4/587; H01M 10/0525; H01M 10/0587; H01M 10/056

(52) U.S. Cl. CPC H01M 4/587; H01M 10/0525; H01M 2004/021; H01M 10/056; H01M 10/0587

(57) ABSTRACT

Provided is a lithium ion secondary battery in which increases in resistance upon repeated charging and discharging are suppressed even when using a high-concentration nonaqueous electrolyte solution. The lithium ion secondary battery disclosed herein has an electrode body having a positive electrode and a negative electrode, and a nonaqueous electrolyte solution. The negative electrode has a negative electrode active material layer containing a negative electrode active material. The negative electrode active material includes hollow particles having a shell portion made up of a carbon material and a hollow portion formed in the interior of the shell portion. The hollow portion of the hollow particles contains a nonaqueous electrolyte solution. The proportion of the amount of Li in the hollow portion of the hollow particles relative to the amount of Li necessary for charging and discharging the lithium ion secondary battery is 32% or higher.

### BACKGROUND OF THE INVENTION

### 1. Field of the Invention

The present disclosure relates to a lithium ion secondary battery. The present application claims priority based on Japanese Patent Application No. 2020-199330 filed on Dec. 1, 2020, the entire contents of which are incorporated in the present specification by reference.

### 2. Description of the Related Art

In recent years, lithium ion secondary batteries have come to being suitably used as portable power sources in personal computers, mobile terminals and the like, and as power sources for vehicle drive in battery electric vehicles (BEV), hybrid electric vehicles (HEV) and plug-in hybrid electric vehicles (PHEV).

A nonaqueous electrolyte solution of a lithium ion secondary battery contains a nonaqueous solvent and an electrolyte salt (supporting salt). A higher concentration of the electrolyte salt entails a higher ion density in the nonaqueous electrolyte solution, which is advantageous, but as a trade-off, the viscosity of the nonaqueous electrolyte solution increases as well. Accordingly, the viscosity of the nonaqueous electrolyte solution is high in a nonaqueous lithium ion secondary battery that utilizes a conventional high-concentration electrolyte solution, and as a result lithium ions reach with difficulty the vicinity of a negative electrode collector of a negative electrode active material layer, and so-called salt concentration unevenness occurs in the thickness direction of the negative electrode active material layer. Moreover, the nonaqueous electrolyte solution drains out of the electrode body due to expansion and contraction of the negative electrode active material upon repeated charging and discharging, and salt concentration unevenness occurs also in the width direction of the negative electrode active material layer. This is problematic in that salt concentration unevenness translates into regions of lower salt concentration, which in turn leads to increases in resistance.

Therefore, electrolyte solutions are generally used, in particular in lithium ion secondary batteries, that contain an electrolyte salt (for example LiPF₆) at a concentration of about 1 M (mol/L), in a nonaqueous solvent (see, for instance, Japanese Patent Application Publication No. 2009-38023). Development of a lithium ion secondary battery capable of utilizing a high-concentration nonaqueous electrolyte solution is thus demanded.

### SUMMARY OF THE INVENTION

In view of the above considerations, it is an object of the present disclosure to provide a lithium ion secondary battery in which increases in resistance upon repeated charging and discharging are suppressed even when using a high-concentration nonaqueous electrolyte solution.

The lithium ion secondary battery disclosed herein has: an electrode body having a positive electrode and a negative electrode; and a nonaqueous electrolyte solution. The negative electrode has a negative electrode active material layer containing a negative electrode active material. The negative electrode active material includes hollow particles having a shell portion made up of a carbon material and a hollow portion formed in the interior of the shell portion. The hollow portion of the hollow particles contains a nonaqueous electrolyte solution. The proportion of the amount of Li in the hollow portion of the hollow particles relative to the amount of Li necessary for charging and discharging the lithium ion secondary battery is 32% or higher. By virtue of such a configuration, a lithium ion secondary battery is provided in which increases in resistance upon repeated charging and discharging are suppressed even when using a high-concentration nonaqueous electrolyte solution.

In a desired implementation of the lithium ion secondary battery disclosed herein, the nonaqueous electrolyte solution contains a lithium salt as an electrolyte salt, at a concentration of not less than 2 mol/kg but not more than 4 mol/kg. By virtue of such a configuration, a lithium ion secondary battery using a high-concentration nonaqueous electrolyte solution is provided in which increases in resistance upon repeated charging and discharging are suppressed to a high degree.

In a desired implementation of the lithium ion secondary battery disclosed herein, the proportion of the amount of Li in the hollow portion of the hollow particles relative to the amount of Li necessary for charging and discharging the lithium ion secondary battery is 98% or higher. Such a configuration allows further suppressing increases in resistance upon repeated charging and discharging of the lithium ion secondary battery.

In a desired implementation of the lithium ion secondary battery disclosed herein, an average particle size of the hollow particles is not less than 5 μm but not more than 30 μm, and an average diameter of a void of the hollow particles is not less than 2 μm but not more than 20 μm. Such a configuration allows easily bringing out an effect of suppressing increases in resistance upon repeated charging and discharging.

In a desired implementation of the lithium ion secondary battery disclosed herein, the electrode body is a wound electrode body. The effect of suppressing increases in resistance upon repeated charging and discharging of the lithium ion secondary battery is more pronounced in such a configuration.

### BRIEF DESCRIPTION OF THE DRAWINGS

FIG. 1 is a cross-sectional diagram illustrating schematically the internal structure a lithium ion secondary battery according to an embodiment of the present disclosure;

FIG. 2 is a schematic exploded-view diagram illustrating the configuration of a wound electrode body of a lithium ion secondary battery according to an embodiment of the present disclosure;

FIG. 3 is a schematic diagram illustrating diffusion of lithium ions in a negative electrode of a conventional lithium ion secondary battery; and

FIG. 4 is a schematic diagram illustrating the manner in which lithium ions are present in a negative electrode of a lithium ion secondary battery according to an embodiment of the present disclosure.

### DESCRIPTION OF THE PREFERRED EMBODIMENTS

Embodiments of the present disclosure will be explained below with reference to accompanying drawings. Any features other than the matter specifically set forth in the present specification and that may be necessary for carrying out the present disclosure can be regarded as design matter for a person skilled in the art based on conventional art in the relevant field. The present disclosure can be realized on the basis of the disclosure of the present specification and common technical knowledge in the relevant field. In the drawings below, members and portions that elicit identical effects are explained while denoted by identical reference numerals. Dimensional relationships in the figures (for instance, length, width and thickness) do not reflect actual dimensional relationships.

In the present specification, the term “secondary battery” denotes a power storage device in general that is capable of being charged and discharged repeatedly, and encompasses so-called storage batteries and power storage elements such as electrical double layer capacitors. In the present specification, the term “lithium ion secondary battery” denotes a secondary battery that utilizes lithium ions as charge carriers, and in which charging and discharging are realized as a result of movement of charge with lithium ions, between a positive electrode and a negative electrode.

Hereinafter, the present disclosure will be described in detail on the basis of an example of a flat square lithium ion secondary battery provided with a wound electrode body, but the disclosure is not meant to be limited to the disclosure in the embodiments.

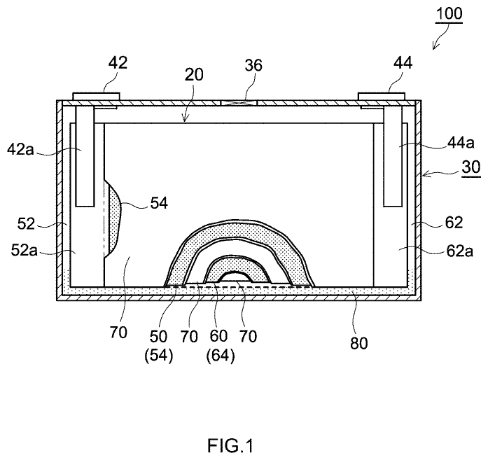

A lithium ion secondary battery 100 illustrated in FIG. 1 is a sealed-type battery constructed by accommodating a flat-shaped wound electrode body 20 and a nonaqueous electrolyte solution 80 in a flat square battery case (i.e. outer container) 30. The battery case 30 is provided with a positive electrode terminal 42 and a negative electrode terminal 44 for external connection, and with a thin-walled safety valve 36 configured to relieve internal pressure in the battery case 30 when the internal pressure rises to or above a predetermined level. An injection port (not shown) for injecting the nonaqueous electrolyte solution 80 is provided in the battery case 30. The positive electrode terminal 42 is electrically connected to a positive electrode collector plate 42a. The negative electrode terminal 44 is electrically connected to a negative electrode collector plate 44a. For instance, a lightweight metallic material of good thermal conductivity, such as aluminum, is used as the material of the battery case 30.

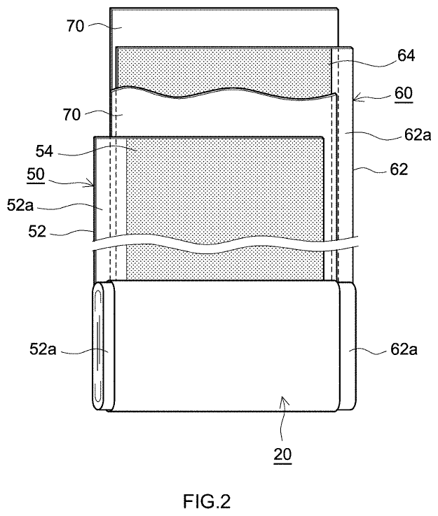

As illustrated in FIG. 1 and FIG. 2, the wound electrode body 20 has a configuration resulting from laminating a positive electrode sheet 50 and a negative electrode sheet 60 with two elongated separator sheets 70 interposed in between, and winding the resulting laminate in the longitudinal direction. The positive electrode sheet 50 has a configuration in which a positive electrode active material layer 54 is formed, in the longitudinal direction, on one or both faces (herein both faces) of an elongated positive electrode collector 52. The negative electrode sheet 60 has a configuration in which a negative electrode active material layer 64 is formed, in the longitudinal direction, on one or both faces (herein both faces) of an elongated negative electrode collector 62. A positive electrode active material layer non-formation portion 52a (i.e. exposed portion of the positive electrode collector 52 at which the positive electrode active material layer 54 is not formed) and a negative electrode active material layer non-formation portion 62a (i.e. exposed portion of the negative electrode collector 62 at which the negative electrode active material layer 64 is not formed) are formed so as to respectively protrude outward from either edge of the wound electrode body 20 in a winding axis direction thereof (i.e. sheet width direction perpendicular to the longitudinal direction). The positive electrode active material layer non-formation portion 52a and the negative electrode active material layer non-formation portion 62a are joined to the positive electrode collector plate 42a and the negative electrode collector plate 44a, respectively.

The nonaqueous electrolyte solution 80 typically contains a nonaqueous solvent and an electrolyte salt (supporting salt). For instance, various carbonates, ethers, esters, nitriles, sulfones, lactones or the like that are used in electrolyte solutions of lithium ion secondary batteries in general can be used, without particular limitations, as the nonaqueous solvent. Desired among the foregoing are carbonates, concrete examples whereof include, for instance, ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyldifluoromethyl carbonate (F-DMC) and trifluorodimethyl carbonate (TFDMC). Such nonaqueous solvents can be used singly or in combinations of two or more types, as appropriate.

As the electrolyte salt, there can be used, for instance, a lithium salt such as LiPF₆, LiBF₄ or lithium bis(fluorosulfonyl)imide (LiFSI), desirably LiPF₆ among the foregoing. The concentration of the electrolyte salt is typically 0.5 mol/kg or higher. The higher the concentration of the electrolyte salt, the more pronounced is the effect of suppressing increases in resistance upon repeated charging and discharging of the lithium ion secondary battery 100, and the higher is likewise resistance to metallic lithium precipitation. Therefore, the concentration of the electrolyte salt is desirably 1 mol/kg or higher, more desirably 1.75 mol/kg or higher, and yet more desirably 2 mol/kg or higher. On the other hand, the viscosity of the nonaqueous electrolyte solution 80 rises as the concentration of the electrolyte salt increases. Therefore, the concentration of the electrolyte salt is desirably 5 mol/kg or lower, more desirably 4 mol/kg or lower.

So long as the effect of the present disclosure is not significantly impaired thereby, the above nonaqueous electrolyte solution 80 may contain various additives besides the above-described components, for instance, coating film-forming agents such as oxalato complexes; gas generating agents such as biphenyl (BP) and cyclohexyl benzene (CHB); as well as thickeners.

The configuration of the positive electrode sheet 50 may be identical or similar to that of positive electrode sheets in conventionally known lithium ion secondary batteries. The shape of the positive electrode collector 52 is foil-shaped (or sheet-shaped) in the examples illustrated in the figures, but is not limited thereto. The form of the positive electrode collector 52 may be, for instance, a rod, a plate or a mesh. A metal of good conductivity (for instance, aluminum, nickel, titanium, stainless steel or the like) can be used, similarly to conventional lithium ion secondary batteries, as the material of the positive electrode collector 52; desirably the material is aluminum among the foregoing. Aluminum foil is particularly desirable as the positive electrode collector 52.

The dimensions of the positive electrode collector 52 are not particularly limited, and may be determined as appropriate depending on the battery design. In a case where an aluminum foil is used as the positive electrode collector 52, the thickness of the aluminum foil is not particularly limited, and is for instance from 5 μm to 35 μm, desirably from 7 μm to 20 μm.

The positive electrode active material layer 54 contains a positive electrode active material. Examples of positive electrode active materials include lithium-transition metal oxides (for example, LiNi_{1/3}Co_{1/3}Mn_{1/3}O₂, LiNiO₂, LiFeO₂, LiMn₂O₄ and LiNi_{0.5}Mn_{1.5}O₄), and lithium-transition metal phosphate compounds (for example LiFePO₄). A lithium-transition metal phosphate compound (for example LiFePO₄) can be used as the positive electrode active material.

The average particle size of the positive electrode active material is not particularly limited, and may be comparable to the average particle size adopted in conventional lithium ion secondary batteries. The average particle size of the positive electrode active material is typically 25 μm or smaller, and is desirably from 1 μm to 20 μm, and more desirably from 5 μm to 15 μm. It should be noted that in the present specification, the term “average particle size of the active material” denotes the particle size (D50) at which a cumulative frequency is 50%, as volume percentage, in a particle size distribution measured by a laser diffraction/scattering method.

The content of the positive electrode active material in the positive electrode active material layer 54 (i.e. content of the positive electrode active material relative to the total mass of the positive electrode active material layer 54) is not particularly limited, but is desirably 70 mass % or higher, and is more desirably from 80 mass % to 97 mass %, yet more desirably from 85 mass % to 96 mass %.

The positive electrode active material layer 54 may contain components other than the positive electrode active material, and examples of such other components include binders, conductive materials and lithium phosphate.

For instance, polyvinylidene fluoride (PVDF) can be used as the binder. The content of the binder in the positive electrode active material layer 54 is not particularly limited, and is, for instance, from 0.5 mass % to 15 mass %, desirably from 1 mass % to 10 mass %, and more desirably from 1.5 mass % to 8 mass %.

For instance, carbon black such as acetylene black (AB), or other carbon materials (for instance, graphite), can be used as the conductive material. The content of the conductive material in the positive electrode active material layer 54 is not particularly limited, but is desirably from 0.1 mass % to 20 mass %, more desirably from 1 mass % to 15 mass %, and yet more desirably from 2 mass % to 10 mass %.

Examples of lithium phosphate include trilithium phosphate (Li₃PO₄). The content of lithium phosphate is not particularly limited, but desirably the content of lithium phosphate is from 0.5 mass % to 15 mass %, more desirably from 1 mass % to 10 mass %, relative to the positive electrode active material.

The shape of the negative electrode collector 62 is foil-shaped (or sheet-shaped) in the examples illustrated in the figures, but is not limited thereto. The form of the negative electrode collector 62 may be, for instance, a rod, a plate or a mesh. A metal of good conductivity (for instance, copper, nickel, titanium, stainless steel or the like) can be used, similarly to conventional lithium ion secondary batteries, as the material of the negative electrode collector 62; desirably the material is copper among the foregoing. A copper foil is particularly desirable as the negative electrode collector 62.

The dimensions of the negative electrode collector 62 are not particularly limited, and may be determined as appropriate depending on the battery design. In a case where a copper foil is used as the negative electrode collector 62, the thickness of the copper foil is not particularly limited, and is, for instance, from 5 μm to 35 μm, desirably from 7 μm to 20 μm.

The negative electrode active material layer 64 contains a negative electrode active material. In the present embodiment, hollow particles of a carbon material are used as the negative electrode active material. Specifically, the negative electrode active material used in the present embodiment is hollow particles having a shell portion made up of a carbon material, and a hollow portion formed in the interior of the shell portion. The shell portion of the hollow particles may have a through-hole through which the nonaqueous electrolyte solution 80 can pass. In this case, the nonaqueous electrolyte solution 80 can be easily incorporated into the hollow portion of the hollow particles.

The type of carbon material is not particularly limited, so long as it is capable of storing and releasing lithium ions; examples of the carbon material include graphite, hard carbon and soft carbon. Graphite is desired among the foregoing.

In the present embodiment, the hollow portion of the hollow particles of the carbon material contains the nonaqueous electrolyte solution 80. The nonaqueous electrolyte solution 80 contains a lithium salt as the electrolyte salt, and hence lithium (Li) is present in the form of ions in the hollow portion of the hollow particles of the carbon material. Concerning lithium, in the present embodiment, the proportion of the amount of Li in the hollow portion relative to the amount of Li necessary for charging and discharging the lithium ion secondary battery 100 is 32% or higher.

It should be noted that the amount of Li necessary for charging and discharging the lithium ion secondary battery 100 denotes the amount of Li necessary for charging and discharging the lithium ion secondary battery 100 from a SOC (state of charge) of 0% up to a SOC of 100%.

The proportion (%) of the amount of Li in the hollow portion relative to the amount of Li necessary for charging and discharging the lithium ion secondary battery 100 can be obtained by converting the value calculated in accordance with the expression below to a percentage.

$$\frac{Amount of Li in hollow portion}{Amount of Li necessary for charging / discharge} = \frac{( A / 1000 ) \times D}{\{ ρ \times ( C - D ) \times E \times B \times ( 3.6 / F ) \} \times G} \qquad [ Math . 1 ]$$

A: concentration of electrolyte salt in the nonaqueous electrolyte solution 80 (mol/L)

B: capacity ratio of negative electrode and positive electrode (capacity of negative electrode/capacity of positive electrode)

C: apparent volume of the hollow particles (cm³)

D: volume of the hollow portion of the hollow particles (cm³)

ρ: true density (g/cm³) of carbon material (2.23 g/cm³ in the case of graphite)

E: theoretical capacity (Ah/g) of the carbon material (372 mAh/g in the case of graphite)

F: faraday constant=96485 (C/mol)

G: SOC range (%) of use=100

The capacity ratio of the negative electrode and the positive electrode can be calculated using the amount and theoretical capacity of the active materials that are used. The apparent volume of the hollow particles can be calculated using the average particle diameter (D50) described below. The volume of the hollow portion of the hollow particles can be calculated using the average diameter of the void portion of the hollow particles described below.

As described above, increases in resistance upon repeated charging and discharging of the lithium ion secondary battery 100 can be suppressed by using hollow particles of a carbon material as the negative electrode active material, and by incorporating a nonaqueous electrolyte solution 80 into the hollow portion of the hollow particles in such a manner that a predetermined amount of Li is present.

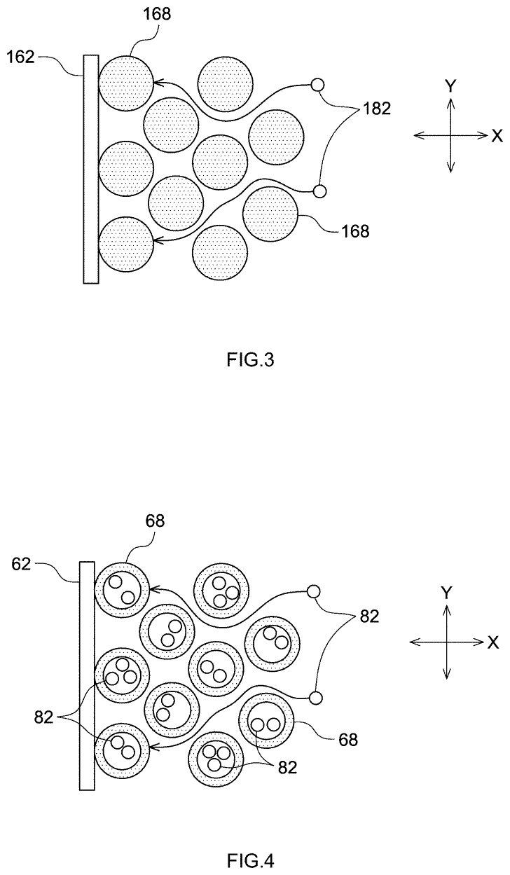

FIG. 3 illustrates an example of a negative electrode in conventional art. FIG. 4 illustrates an example of a negative electrode of the present embodiment. As denoted by the arrow in FIG. 3, lithium ions 182 have to move across the gaps between negative electrode active material particles 168 to reach a negative electrode collector 162. In a case where a high-concentration nonaqueous electrolyte solution is used, lithium ions 182 diffuse with difficulty on account of the high viscosity of the nonaqueous electrolyte solution, and as a result the lithium ions 182 do not reach readily the negative electrode active material particles 168 in the vicinity of the negative electrode collector 162. The lithium ion concentration in the vicinity of the negative electrode collector 162 is therefore low. As a result, the concentration of lithium ions in the thickness direction (X direction in the drawings) of the negative electrode active material layer becomes non-uniform (i.e. so-called salt concentration unevenness occurs). In particular, salt concentration unevenness becomes significant upon repeated charging and discharging of the lithium ion secondary battery 100. The nonaqueous electrolyte solution is drained out of the electrode body due to expansion/contraction of the negative electrode active material particles 168 upon repeated charging and discharging of the lithium ion secondary battery 100, and thus salt concentration unevenness occurs also in the width direction (Y direction in the drawings) of the negative electrode active material layer. Such salt concentration unevenness results in regions of lower salt concentration, which in turn gives rise to increases in resistance.

In the present embodiment, by contrast, the negative electrode active material particles 68 are hollow particles, as illustrated in FIG. 4, and the hollow particles contain the nonaqueous electrolyte solution 80 in the hollow portion; as a result, the electrolyte salt (i.e. lithium ions 82) is present in the interior of negative electrode active material particles 68 (FIG. 4 does not illustrate the amount of lithium ions 82 in a strict fashion). A predetermined amount of lithium ions 82 can therefore be allowed to be present also at a portion in the negative electrode active material layer 64 of low lithium ion concentration (in particular in the vicinity of the negative electrode collector 62). In consequence, this allows reducing salt concentration unevenness, which in turn makes it possible to suppress increases in resistance derived from salt concentration unevenness.

Also resistance to metallic lithium precipitation is improved by using hollow particles of the carbon material as the negative electrode active material, and by incorporating the nonaqueous electrolyte solution 80 so that a predetermined amount of Li is present in the hollow portion of the hollow particles.

The higher the proportion (%) of the amount of Li in the hollow portion relative to the amount of Li necessary for charging and discharging the lithium ion secondary battery 100, the greater the extent to which salt concentration unevenness can be reduced. Accordingly, the higher the proportion of the amount of Li in the hollow portion, the more pronounced is the effect of suppressing increases in resistance and the effect of improving resistance to metallic lithium precipitation. Therefore, the proportion of the amount of Li in the hollow portion is desirably 50% or higher, more desirably 75% or higher, and yet more desirably 98% or higher. The upper limit of the proportion of the amount of Li in the hollow portion is not particularly restricted, and may be 200% or lower, or 150% or lower.

The particle size of the hollow particles, the thickness of the shell portion and the void diameter of the hollow portion are not particularly limited. The average particle size of the hollow particles is desirably not less than 5 μm but not more than 30 μm, and more desirably not less than 7 μm but not more than 25 μm, since in that case the proportion of the amount of Li in the hollow portion can be readily increased, i.e. the effect of suppressing increases in resistance, and the effect of improving the resistance to metallic lithium precipitation can be brought out yet more readily. The average diameter of the void of the hollow particles is desirably not less than 2 μm but not more than 20 μm, more desirably not less than 5 μm but not more than 15 μm. The average thickness of the shell portion of the hollow particles is desirably not less than 2 μm but not more than 10 μm.

The average particle size of the hollow particles can be determined as the particle size (D50) at which a cumulative frequency is 50%, as volume percentage, in a particle size distribution measured by a laser diffraction/scattering method. The average thickness of the shell portion of the hollow particles and the average diameter of the void portion of the hollow particles can be determined by capturing a cross-sectional electron micrograph of 50 or more hollow particles, obtaining the thickness of the shell portions and void diameter in the captured image, and calculating an average of the results.

The number of hollow portions of the hollow particles is not particularly limited, and may be one or a plurality. The number of hollow portions in the hollow particles is desirably from 1 to 10.

The content of the negative electrode active material in the negative electrode active material layer 64 (i.e. the content of negative electrode active material relative to the total mass of the negative electrode active material layer 64) is not particularly limited, but is desirably 70 mass % or higher, more desirably from 80 mass % to 99.5 mass % and yet more desirably from 85 mass % to 99 mass %.

The negative electrode active material layer 64 may contain components other than the negative electrode active material, and examples of such components include a binder and a thickener.

As the binder, there can be used, for instance, a styrene butadiene rubber (SBR) or a modified product thereof, an acrylonitrile butadiene rubber or a modified product thereof, an acrylic rubber or a modified product thereof, as well as a fluororubber. Among the foregoing, SBR is desirably used. The content of the binder in the negative electrode active material layer 64 is not particularly limited, but is desirably from 0.1 mass % to 8 mass %, more desirably from 0.2 mass % to 3 mass %.

For instance, a cellulosic polymer such as carboxymethyl cellulose (CMC), methyl cellulose (MC), cellulose acetate phthalate (CAP) or hydroxypropyl methyl cellulose (HPMC); or polyvinyl alcohol (PVA) can be used herein as the thickener. Among the foregoing CMC, is desirably used. The content of thickener in the negative electrode active material layer 64 is not particularly limited, but is desirably from 0.3 mass % to 3 mass %, more desirably from 0.4 mass % to 2 mass %.

Examples of the separator 70 include a porous sheet (film) made of a resin such as polyethylene (PE), polypropylene (PP), polyester, cellulose or polyamide. Such a porous sheet may have a single-layer structure or a multilayer structure of two or more layers (for instance, a three-layer structure in which PP layers are laid on both faces of a PE layer). A heat resistant layer (HRL) may be provided on the surface of the separator 70.

In the lithium ion secondary battery 100 configured as described above, increases in resistance upon repeated charging and discharging are suppressed. Also precipitation of metallic lithium is suppressed in the lithium ion secondary battery 100.

The lithium ion secondary battery 100 can be used in various applications. Suitable examples of applications include drive power sources mounted on vehicles such as battery electric vehicles (BEV), hybrid electric vehicles (HEV), and plug-in hybrid electric vehicles (PHEV). Further, the lithium ion secondary battery 100 can be used as a storage battery for a small power storage device and the like. The lithium ion secondary battery 100 may also be used typically in the form of a battery pack in which a plurality of the lithium ion secondary batteries 100 are connected in series and/or in parallel.

The explanation above concerns a square lithium ion secondary battery 100 provided with a flat-shaped wound electrode body 20 as an example. However, the lithium ion secondary battery 100 can also be configured in the form of a lithium ion secondary battery that has a stacked-type electrode body (i.e. electrode body in which multiple positive electrodes and multiple negative electrodes are alternately laid up on each other). Upon repeated charging and discharging of the lithium ion secondary battery 100, the nonaqueous electrolyte solution becomes drained out of the electrode body due to expansion/contraction of the negative electrode active material; herein the nonaqueous electrolyte solution returns more readily to a stacked-type electrode body than to a wound electrode body. Uneven salt concentration is therefore more likely to occur in a wound electrode body. Accordingly, the effect of the present disclosure is more pronounced when the electrode body of the lithium ion secondary battery 100 is a wound electrode body.

The lithium ion secondary battery 100 can be configured in the form of a cylindrical lithium ion secondary battery, a laminate-cased lithium ion secondary battery or the like.

Examples pertaining to the present disclosure will be explained below, but the present disclosure is not meant to be limited to the features illustrated in the examples.

Production of Lithium Ion Secondary Batteries for Evaluation

Respective negative electrode pastes was prepared by mixing a negative electrode active material (C) given in Table 1, CMC as a thickener, and SBR as a binder, at a mass ratio of C:CMC:SBR=97:1:2, with ion-exchanged water. Each negative electrode paste was applied, in the form of a strip, onto both sides of an elongated copper foil, and dried. Then, the resultant was pressed to produce a negative electrode sheet. Normal graphite particles (solid graphite particles) having no hollow portion were used in Comparative examples 1 to 3. In Examples 1 to 6, hollow graphite particles were used, with the average particle size and internal void diameter of the particles being modified so that there varied the proportion of the amount of Li in the hollow portion relative to the amount of Li necessary for charging and discharging the lithium ion secondary battery.

A positive electrode paste was prepared by mixing LiNi_{1/3}Co_{1/3}Mn_{1/3}O₂ (LNCM) as a positive electrode active material, acetylene black (AB) as a conductive material and polyvinylidene fluoride (PVdF) as a binder, at a mass ratio of LNCM:AB:PVdF=90:8:2, with N-methylpyrrolidone (NMP). This slurry was applied, in the form of a strip, on both faces of an elongated aluminum foil, and dried. Then, the resultant was pressed to produce a positive electrode sheet.

A porous polyolefin sheet having a three-layer structure of PP/PE/PP provided with an HRL was prepared as a separator. The positive electrode sheet and each negative electrode sheet produced above, plus two of the separator sheets prepared above, were laid up on each other and wound, and thereafter the resultant was squashed through pressing in a lateral direction, to thereby produce a respective flat-shaped wound electrode body.

Next, a positive electrode terminal and a negative electrode terminal were connected to the wound electrode body, and the resultant was accommodated in a square battery case having an electrolyte solution injection port. A nonaqueous electrolyte solution was then injected through the electrolyte solution injection port of the battery case, and the injection port was sealed hermetically. The nonaqueous electrolyte solution was prepared by dissolving LiPF₆ as an electrolyte salt, to the concentration given in Table 1, in a mixed solvent of ethylene carbonate (EC), dimethyl carbonate (DMC) and ethyl methyl carbonate (EMC), at a volume ratio of EC:DMC:EMC=3:3:4, with further addition of LiBOB up to the concentration of 0.5 mass %. An aging treatment was then carried out to yield respective lithium ion secondary batteries for evaluation of the examples and comparative examples.

Measurement of Li Diffusion Resistance

Two uncharged negative electrodes were superimposed on each other and a Cole-Cole plot was obtained by AC impedance measurement. The ion diffusion resistance of the uncharged negative electrodes was obtained through fitting of the —R— resistance and -Wo-diffusion resistance in the obtained Cole-Cole plot. A ratio with respect to the value of diffusion resistance of the negative electrode of the battery of Comparative example 1 when this value was taken as 100 was determined in Examples 1 to 4 and Comparative example 2. In Example 5, there was determined a ratio with respect to the value of diffusion resistance of the negative electrode of the battery of Comparative example 3 when this value was taken as 100. In Example 6 there was determined a ratio with respect to the value of diffusion resistance of the negative electrode of the battery of Comparative example 4 when this value was taken as 100. The results are given in Table 1.

Cycle Characteristic Evaluation—Suppression of Increases in Resistance

Each lithium ion secondary battery for evaluation was adjusted to a state of SOC of 60% under temperature conditions of 25° C., and constant current charging for 10 seconds was carried out at 15 mA. The initial resistance was then calculated based on the amount of change in voltage and a current value. The resistance of each lithium ion secondary battery for evaluation was then measured, in the same way as for the initial resistance, after each time when charging and discharging with a pre-set pulse current was repeated over a predetermined number of cycles. A high-rate current value was employed as the current value. The number of cycles at which this resistance value was 1.06 times larger than the initial resistance was determined. A ratio relative to the value of the number of cycles of the battery of Comparative example 1 when this value was taken as 100 was determined in Examples 1 to 4 and Comparative example 2. A ratio relative to the value of the number of cycles of the battery of Comparative example 3 when this value was taken as 100 was determined in Example 5. A ratio relative to the value of the number of cycles of the battery of Comparative example 4 when this value was taken as 100 was determined in Example 6. The results are given in Table 1. The higher this ratio, the higher is the performance of suppression of increases in resistance.

Resistance to Metallic Lithium Precipitation—Capacity Retention Rate

Each lithium ion secondary battery for evaluation was placed in an environment at 25° C. The lithium ion secondary battery for evaluation was subjected to a constant current-constant voltage charging (cut current: 1/50 C) at a current value of ⅕ C up to 4.1 V, 10-minute rest, and constant current discharging at a current value of ⅕ C down to 3.0 V. The discharge capacity at this time was measured, and the result was taken as the initial capacity. The lithium ion secondary battery for evaluation was repeatedly charged and discharged with a preset pulse current, over a predetermined number of cycles. A high-rate current value was employed as the current value. Capacity was then measured in a similar manner to initial capacity. A capacity retention rate was determined from the equation: capacity retention rate (%)=(capacity after charging and discharging cycles/initial capacity)×100. A ratio relative to the value of the capacity retention rate of the battery of Comparative example 1 when this value was taken as 100 was determined in Examples 1 to 4 and Comparative example 2. A ratio relative to the value of the capacity retention rate of the battery of Comparative example 3 when this value was taken as 100 was determined in Example 5. A ratio relative to the value of the capacity retention rate of the battery of Comparative example 4 when this value was taken as 100 was determined in Example 6. The results are given in Table 1. The higher this ratio, the higher is the resistance to metallic lithium precipitation.

### [Table 1]

TABLE 1

| | Negative | Li amount in hollow | Electrolyte | Li | Evaluation of | Evaluation of |
|---|---|---|---|---|---|---|
| | electrode | portion/Li amount | salt | diffusion | resistance | resistance to |
| | active | necessary for | concentration | resistance | increase | metallic lithium |
| | material | charging-discharging | (mol/kg) | ratio | suppression | precipitation |
| Comp. | Solid graphite | 5% or less | 2 | 100 | 100 | 100 |
| example 1 | particles | | | | | |
| Comp. | Hollow graphite | 26% | 2 | 101 | 101 | 98 |
| example 2 | particles | | | | | |
| Example 1 | Hollow graphite | 32% | 2 | 98 | 110 | 104 |
| | particles | | | | | |
| Example 2 | Hollow graphite | 59% | 2 | 96 | 121 | 113 |
| | particles | | | | | |
| Example 3 | Hollow graphite | 98% | 2 | 82 | 182 | 165 |
| | particles | | | | | |
| Example 4 | Hollow graphite | 132% | 2 | 80 | 181 | 164 |
| | particles | | | | | |
| Comp. | Solid graphite | 5% or less | 1 | 100 | 100 | 100 |
| example 3 | particles | | | | | |
| Example 5 | Hollow graphite | 34% | 1 | 98 | 103 | 104 |
| | particles | | | | | |
| Comp. | Solid graphite | 5% or less | 4 | 100 | 100 | 100 |
| example 4 | particles | | | | | |
| Example 6 | Hollow graphite | 33% | 4 | 90 | 134 | 142 |
| | particles | | | | | |

As the results of Table 1 indicate, a comparison among Comparative examples 1 and 2 and Examples 1 to 4 reveals that increases in resistance after charge and discharge cycles were significantly suppressed in a case where the proportion of the amount of Li in the hollow portion relative to the amount of Li necessary for charging and discharging the lithium ion secondary battery was 32% or higher. It is found that also resistance to metallic lithium precipitation is improved. It is also found that the higher the proportion of the amount of Li in the hollow portion, the greater is the extent to which increases in resistance and metallic lithium precipitation can be suppressed.

A comparison among Comparative examples 1, 3 and 4 and Examples 1, 5 and 6 reveals that the higher the concentration of electrolyte salt in the nonaqueous electrolyte solution, the greater is the extent to which it becomes possible to suppress increases in resistance upon repeated charging and discharging of the lithium ion secondary battery, and suppress metallic lithium precipitation. In particular, the concentrations of the electrolyte salt in Examples 1 and 6 were 2 mol/kg and 4 mol/kg, and it is thus found that a superior effect of suppressing increases in resistance upon repeated charging and discharging and excellent resistance to metallic lithium precipitation can be achieved also in a high-concentration nonaqueous electrolyte solution.

From all the above, it can be understood that the lithium ion secondary battery disclosed herein can suppress increases in resistance upon repeated charging and discharging, and suppress precipitation of metallic lithium, even when using a high-concentration nonaqueous electrolyte solution.

Concrete examples of the present disclosure have been explained in detail above, but the examples are merely illustrative in nature, and are not meant to limit the scope of the claims in any way. The art set forth in the claims encompasses various alterations and modifications of the concrete examples illustrated above.

What is claimed is:

1. A lithium ion secondary battery, comprising:
an electrode body having a positive electrode and a negative electrode; and
a nonaqueous electrolyte solution,
wherein the negative electrode has a negative electrode active material layer containing a negative electrode active material;
the negative electrode active material includes hollow particles having a shell portion made up of a carbon material and a hollow portion formed in the interior of the shell portion;
the hollow portion of the hollow particles contains a nonaqueous electrolyte solution; and
the proportion of the amount of Li in the hollow portion of the hollow particles relative to the amount of Li necessary for charging and discharging the lithium ion secondary battery is 32% or higher.

2. The lithium ion secondary battery according to claim 1, wherein the nonaqueous electrolyte solution contains a lithium salt as an electrolyte salt, at a concentration of not less than 2 mol/kg but not more than 4 mol/kg.

3. The lithium ion secondary battery according to claim 1, wherein the proportion of the amount of Li in the hollow portion of the hollow particles relative to the amount of Li necessary for charging and discharging the lithium ion secondary battery is 98% or higher.

4. The lithium ion secondary battery according to claim 1, wherein an average particle size of the hollow particles is not less than 5 μm but not more than 30 μm, and an average diameter of a void of the hollow particles is not less than 2 μm but not more than 20 μm.

5. The lithium ion secondary battery according to claim 1, wherein the electrode body is a wound electrode body.
